(19) United States
(12) Patent Application Publication
(10) Pub. No.: US 2007/0011489 A1
(43) Pub. Date: Jan. 11, 2007

(54) Command processing method for RAID

(75) Inventors: Yong Li, Taipei (TW); Yajun Wu, Taipei (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/300,333

(22) Filed: Dec. 15, 2005

(30) Foreign Application Priority Data
Jul. 11, 2005 (TW) 094123402

(51) Int. Cl. G06F 11/00

(52) U.S. Cl. 714/6

(57) ABSTRACT

A command processing method for an RAID is performed when a usable memory of a system is smaller than a size of a command. The command processing method for the RAID includes the following steps of: dividing the command into a plurality of segmented commands, transmitting the segmented commands to the usable memory in order, and performing the segmented commands by a controller in order.

### BACKGROUND OF THE INVENTION

1. Field of Invention

The invention relates to a command processing method and, in particular, to a command processing method for an RAID.

2. Related Art

A hard disk (HD) is one of the most popular storage devices in the personal computer (PC). In the PC, the access speed of the HD, which is slower than that of CPU and RAM, is one of the key points lowering the system speed. Recently, the servers are widely applied, and the professional audio/video (AV) system needs the storage device with large capacity and high speed. In order to speed up the flow of the computer system for enhancing the process performance, the redundant arrays of inexpensive disks (RAID) system has became the best choice.

The RAID system is to simulate a logic hard disk in the system with more than two hard disks, and an RAID controller is used to simulate the various RAID prototypes according to the array types. At present, the popular RAID prototypes are RAID 0, RAID 1, RAID 3, RAID 4, and RAID 5.

A conventional write command processing method for the RAID, such as RAID 5, includes the steps of dividing one data into a plurality of segmented data, storing the segmented data into the different hard disks, obtaining the parity data by an XOR logic operation of the segmented data, and writing the parity data into the hard disk. Herein, the number of the segmented data is depended on the number of the hard disks. In this case, the size of the write command issued by the system is 64K bytes, 128K bytes, or other size of command.

The write command can be performed by the system through the dynamic random access memory (DRAM) if the capacity of the DRAM is sufficient. However, the usable memory of the system may be limited when the system performs at a power management period or an OS loading period. For example, when the system performs at the power management period, the capacity of the usable memory limited by a miniport driver is about 32K bytes. Besides, when the system performs at the OS loading period, the capacity of the usable memory of the system is smaller than 128K bytes. Therefore, the write command cannot be performed and the data cannot be written into the RAID by the system. Even worse, the system may malfunction, which causes troubles of the user.

It is therefore an important subject of the invention to perform the write command and to write the data into the RAID when the usable memory of the system is insufficient.

### SUMMARY OF THE INVENTION

In view of the foregoing, the invention is to provide a command processing method for an RAID, which can perform the RAID command when a size of a system memory is insufficient.

To achieve the above, a command processing method for an RAID of the invention is performed when a capacity of a usable memory of a system is smaller than a size of a command. The command processing method for the RAID includes the following steps. First, the command is divided into a plurality of segmented commands. Then, the segmented commands are transmitted to the usable memory in sequence. Finally, a controller performs the segmented commands in sequence.

In addition, the invention also disclosed a command processing method for an RAID, which divides a command into a plurality of segmented commands when a capacity of a usable memory of a system is smaller than a size of the command. In this case, a size of each segmented command is smaller than the capacity of the usable memory.

As mentioned above, the command processing method for the RAID of the invention divides the command into a plurality of segmented commands and performs the segmented commands in sequence by the system. Thus, the problem of the system cannot perform the command when the capacity of the usable memory is insufficient can be solved. Furthermore, the method can avoid the malfunction of the system, resulting in the troubles of the user, when the capacity of the usable memory is insufficient.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a hardware configuration cooperated with a command processing method for an RAID according to an embodiment of the invention;

FIG. 2 is a schematic diagram showing another hardware configuration cooperated with the command processing method for the RAID according to the embodiment of the invention; and

FIG. 3 is a flow chart showing the command processing method for the RAID according to the embodiment of the invention.

### DETAILED DESCRIPTION OF THE INVENTION

The command processing method for an RAID of the invention will be apparent from the following detailed description, which proceeds with reference to the accompanying drawings, wherein the same references relate to the same elements.

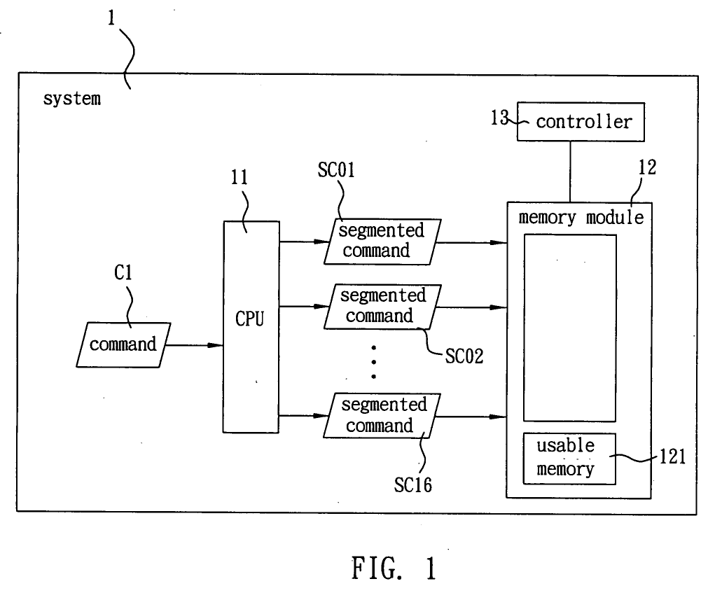

Referring to FIG. 1, a system 1 cooperated with the command processing method for the RAID includes a CPU 11, a memory module 12, and a controller 13. In the embodiment, the memory module 12 has a usable memory 121 when the system 1 is at an OS loading period or a power management period.

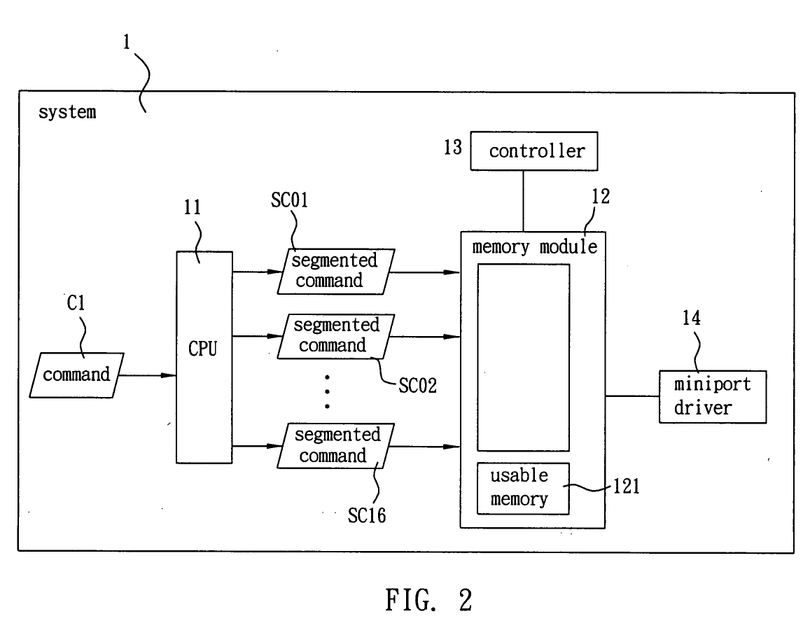

When the system 1 is at the OS loading period, the usable memory 121 is a part of the read-only memory (ROM), and the capacity of the ROM is 640 Kbytes. Referring to FIG. 2, when the system 1 is at the power management period, the usable memory 121 is a part of dynamic random access memory (DRAM). Herein, a miniport driver sets the capacity of the usable memory 121.

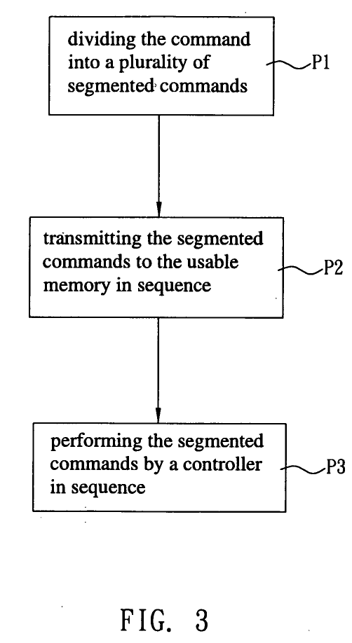

Referring to FIG. 2 and FIG. 3, the command processing method according to the embodiment of the invention performs while the capacity of the usable memory 121 of the system 1 is smaller than the size of a command C1. In the embodiment, the size of the command C1 is 64K bytes and the capacity of the usable memory 121 is 32K bytes limited by the miniport driver. In addition, the command C1 is a write command, which allows the system 1 to write a data into an RAID. The RAID can be RAID 3, RAID 4, or RAID 5.

The command processing method for the RAID according to the embodiment of the invention includes the following steps.

First, the procedure P1 is to divide the command C1 into a plurality of segmented commands SC01 to SC16 by the CPU 11 of the system 1. In the embodiment, the command C1 is divided into sixteen segmented commands SC01 to SC16, which have a size of 4K bytes respectively. In some cases, the command C1 may be divided into a plurality of segmented commands with other size (e.g. 8K bytes) in accordance with the different size of the command C1 and the different capacity of the usable memory 121, so that the system 1 can perform the segmented commands successfully.

Then, the procedure P2 is to transmit the segmented commands SC01 to SC16 into the usable memory 121 of the memory module 12 in sequence by the CPU 11. In the embodiment, the usable memory 121 is a part of the DRAM.

Finally, the procedure P3 is to perform the segmented commands SCOL to SC16 in sequence by the controller 13, so that the data can be written into the RAID by the system 1. In the embodiment, controller 13 may be a RAID controller and the data can be written into the RAID by the RAID controller.

Therefore, the system 1 can finish the duty for writing the data into the RAID after performing the segmented commands with 4K bytes sixteen times. Certainly, the system 1 is not limited to execute sixteen times to finish the write command. In practice, the command may be divided into different numbers of segmented commands with different sizes, and the system 1 must execute all of the segmented commands.

In summary, the command processing method for the RAID of the invention divides the command into a plurality of segmented commands so that the system can perform the segmented commands successfully. This is because that the size of the segmented commands is smaller than the capacity of the usable memory. Compared with the conventional command processing method, the command processing method for the RAID of the invention can make the system to write the data into the RAID successfully when the usable memory is insufficient.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A command processing method for an RAID performed while a capacity of a usable memory of a system is smaller than a size of a command, the processing method comprising:
dividing the command into a plurality of segmented commands;
transmitting the segmented commands to the usable memory in sequence; and
performing the segmented commands by a controller in sequence.

2. The command processing method according to claim 1, wherein the system has an RAID with RAID 3, RAID 4, or RAID 5.

3. The command processing method according to claim 1, wherein the size of each of the segmented commands is 4 Kbytes.

4. The command processing method according to claim 1, which is performed at a power management period.

5. The command processing method according to claim 4, wherein the usable memory is a part of a dynamic random access memory (DRAM).

6. The command processing method according to claim 4, wherein the capacity of the usable memory is regulated with a miniport driver.

7. The command processing method according to claim 1, which is performed at an OS loading period.

8. The command processing method according to claim 7, wherein the usable memory is a part of a read-only memory (ROM).

9. The command processing method according to claim 1, wherein the command is a writing command.

10. The command processing method according to claim 1, wherein the controller is an RAID controller.

11. The command processing method according to claim 1, wherein the command is divided into the segmented commands with a CPU.

12. A command processing method for an RAID, comprising:
dividing a command into a plurality of segmented commands when a capacity of a usable memory of a system is smaller than a size of the command;
wherein a size of each segmented command is smaller than the capacity of the usable memory.

13. The command processing method according to claim 12, wherein the system has an RAID with RAID 3, RAID 4, or RAID 5.

14. The command processing method according to claim 12, wherein the size of each of the segmented commands is 4 Kbytes.

15. The command processing method according to claim 12, which is performed at a power management period.

16. The command processing method according to claim 15, wherein the usable memory is a part of a dynamic random access memory (DRAM).

17. The command processing method according to claim 16, wherein the capacity of the usable memory is regulated with a miniport driver.

18. The command processing method according to claim 12, which is performed at an OS loading period.

19. The command processing method according to claim 18, wherein the usable memory is a part of a read-only memory (ROM).

20. The command processing method according to claim 12, wherein the command is a writing command.

21. The command processing method according to claim 12, wherein the command is divided into the segmented commands with a CPU.
